(19) United States
(12) Patent Application Publication
(10) Pub. No.: US 2025/0354329 A1
(43) Pub. Date: Nov. 20, 2025

(54) PERMEABLE BACKING AND TUFTED ARTICLES COMPRISING SAID BACKING

(71) Applicant: SHAW INDUSTRIES GROUP, INC., Dalton, GA (US)

(72) Inventors: Gregory D. Fowler, Ringold, GA (US); Michael Mathis, Dalton, GA (US)

(21) Appl. No.: 18/864,717

(22) PCT Filed: May 10, 2023
(86) PCT No.: PCT/US2023/021667

§ 371 Date: Nov. 11, 2024

Related U.S. Application Data
(60) Provisional application No. 63/340,545, filed on May 11, 2022.
(60) Provisional application No. 63/347,069, filed on May 31, 2022.

(51) Int. Cl. D06N 7/00; B32B 5/02; B32B 5/26; D03D 9/00; D03D 13/00; D03D 15/37; D05C 17/02; E01C 13/08

(52) U.S. Cl. CPC D06N 7/0068; B32B 5/024; B32B 5/028; B32B 5/262; D03D 9/00; D03D 13/008; D03D 15/37; D05C 17/023; D06N 7/0071; E01C 13/08; B32B 2255/02; B32B 2255/26; B32B 2307/718; B32B 2471/02; D06N 2203/068; D06N 2211/066; D10B 2503/042; D10B 2505/202

(57) ABSTRACT

Disclosed herein is tufted article including a backing having a vertical axis. The backing includes an open structure material having a first surface and an opposed second surface. The open structure material includes a plurality of fibers. The plurality of fibers define void spaces through the open structure material from the first surface to the second surface in part based on variability of fibers along the vertical axis. The void spaces are configured to permit passage of liquid or vapor from the first surface to the second surface of the open structure material. A scrim layer is coupled to the opposed second surface of the open structure material. The scrim layer has an open mesh structure. A second plurality of fibers are tufted through the backing and extend upwardly from the first surface of the open structure material.

### CROSS-REFERENCE TO RELATED APPLICATIONS

This application claims priority to and the benefit of the filing dates of U.S. Provisional Patent Application Nos. 63/340,545, filed May 11, 2022, and 63/347,069, filed May 31, 2022, the entirety of each of which is hereby incorporated by reference herein for all purposes.

### FIELD

This disclosure relates generally to tufted articles and, in particular, to tufted articles (e.g., tufted artificial turf articles or tufted carpet articles) having a permeable backing layer.

### BACKGROUND

Breathability and water permeability can be important for tufted articles such as carpet and artificial turf. Conventionally, to achieve breathability and water permeability, a backing has perforations formed therethrough. For example, hot needles (e.g., heated conical spikes), drills, or punches can pierce the backing to form the perforations to provide the desired breathability and water permeability. However, formation of such perforations increases manufacturing cost and time, as well as leads to complications such as machine maintenance and manufacturing down time. Thus, a need exists for a backing that is sufficiently breathable or water permeable without requiring an additional process to form perforations through the backing.

### SUMMARY

Described herein, in one aspect, is a tufted article including a backing. The backing includes a plurality of woven fibers defining a woven backing structure having a first surface and an opposed second surface. Void spaces are defined between respective woven fibers of the plurality of woven fibers of the woven backing structure. The void spaces are configured to permit passage of liquid or vapor from the first surface to the second surface of the woven backing structure. A scrim layer is coupled to the opposed second surface of the woven backing structure. The scrim layer has an open mesh structure. The second surface of the woven backing structure and the scrim layer cooperate to define a lower surface of the backing. Optionally, a polymer coating can be applied to the lower surface of the backing. At least a portion of the scrim prevents the polymer coating from entering at least one void space of the void spaces defined between respective woven fibers of the plurality of woven fibers of the woven backing structure.

Disclosed herein, in one aspect, is tufted article including a backing having a vertical axis. The backing includes an open structure material having a first surface and an opposed second surface. The open structure material includes a plurality of fibers. The plurality of fibers define void spaces through the open structure material from the first surface to the second surface in part based on variability of fibers along the vertical axis. The void spaces are configured to permit passage of liquid or vapor from the first surface to the second surface of the open structure material. A scrim layer is coupled to the opposed second surface of the open structure material. The scrim layer has an open mesh structure. A second plurality of fibers are tufted through the backing and extend upwardly from the first surface of the open structure material.

Described herein, in one aspect, is a method of forming a tufted article. The method includes weaving a plurality of fibers together to form a woven backing structure having a first surface and an opposed second surface, the woven backing structure defining void spaces between respective woven fibers of the plurality of woven fibers of the woven backing structure, wherein the void spaces are configured to permit passage of liquid from the first surface to the second surface of the woven backing structure. A second plurality of fibers can be tufted through the backing so that the plurality of fibers extend upwardly from the first surface of the woven backing structure. The method does not include forming openings through the backing.

Described herein, in one aspect, is a method comprising installing a tufted article as disclosed herein on a subfloor. Liquid is received through the void spaces defined between respective woven fibers of the plurality of woven fibers of the woven backing structure.

Additional advantages of the invention will be set forth in part in the description that follows, and in part will be obvious from the description, or may be learned by practice of the invention. The advantages of the invention can be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

These and other features of the preferred embodiments of the invention will become more apparent in the detailed description in which reference is made to the appended drawings wherein:

FIG. 1 is a schematic side view of an exemplary tufted article in accordance with embodiments disclosed herein.

FIG. 2 is a schematic top view of an exemplary woven backing structure of the tufted article of FIG. 1

FIG. 3 is a perspective view of an exemplary woven backing structure for a tufted article as disclosed herein.

FIG. 4 is a perspective view of an exemplary woven backing structure for a tufted article as disclosed herein, with the weft fibers comprising multiple filaments or ribbons.

FIG. 5 shows a perspective view of the exemplary woven backing structure, held at an angle to show light permeating therethrough.

FIG. 6 shows a perspective view of the exemplary woven backing structure, held at an angle to show light permeating therethrough.

FIG. 7 shows a view of a backing having thinner fibers with less undulating profiles than that of FIGS. 3-6.

FIG. 8 shows a scrim layer as disclosed herein.

FIG. 9 shows a backstitch side of a tufted article, as disclosed herein.

FIG. 10 is a top view schematic drawing of an exemplary woven backing structure as disclosed herein.

FIG. 11 is a perspective view of the portion of the woven backing structure of FIG. 10 in the broken line box.

FIG. 12 is a schematic diagram showing an acute angle between axes along which void spaces can extend and the first surface of the woven backing structure.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “a layer” includes one or more of such layers, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

The terms “fiber” and “yarn” as used herein refer to a continuous strand or bundle of filaments. The filaments can include, for example, ribbons (e.g., slit films). Thus, such fibers and yarns can include, for example and without limitation, tape ribbons, monofilament yarns, cut yarns, looped yarns, fibrillated yarns, multifilament yarns, twisted yarns (e.g., twisted staple yarns), wrapped yarns, staple yarns, and the like. Optionally, consistent with the use of the terms “fiber” and “yarn”, the continuous strand or bundles of fibers can be cut to form cut fibers or cut yarns. Optionally, fibers/yarns can be textured using conventional methods. “Fibers” and “yarns” as disclosed herein are capable of being independently delivered to a backing structure (for example, via tufting). A yarn or a fiber can be a single end fiber (single ply yarn) or a multiple end fiber (e.g., a plied yarn) that includes a plurality of single end fibers that are entangled or otherwise commingled with one another (for example, by air entanglement, twisting, wrapping, and the like) such that the single end yarns are no longer individually or independently moveable. For example, a plurality of single end yarns can be twisted together to form a plied yarn (e.g., a two-ply yarn can include two single end yarns that are twisted together). Each single end yarn/fiber can be formed from at least one filament (optionally, a plurality of filaments). Thus, within a multiple end yarn, each single end yarn that makes up the multiple end yarn can include a respective filament or plurality of filaments.

As used herein, the term “denier” refers to the weight in grams of 9,000 meters of yarn. “Denier per filament” refers to the denier (weight in grams of 9,000 meters) of a single filament of a yarn. When the yarn consists of a single end yarn, the “total denier” of the yarn can refer to the combined denier (i.e., the sum of the respective deniers) of all filaments of the single end yarn. When the yarn includes a plurality of yarn ends (a plurality of single end yarns) that are entangled or otherwise commingled with one another such that the yarn ends are no longer individually or independently moveable, then the “total denier” of the yarn can refer to the combined denier (i.e., the sum of the respective deniers) of the plurality of yarn ends (the plurality of single end yarns that define the multiple end yarn).

The total denier, denier per fiber (dpf), and ply information can be used to determine the number of filaments within a given yarn. As a first example, a single-ply yarn can be identified as a 6000 total denier, 4 dpf yarn. This indicates that the single-ply yarn has a total denier of 6000, and that each filament of the single-ply yarn has a denier (per filament) of 4. The total number of filaments can be determined by dividing the total denier (6000) by the dpf (4), producing a result of 1500 filaments within the yarn. Rather than identifying the yarn as a 6000 total denier, 4 dpf yarn, it is contemplated that the yarn can instead be identified as a 6000/1500 filament yarn (with the dpf (4) being determined by dividing the total denier (6000) by the number of filaments (1500)).

As another example, consider a two-ply yarn that has the same total denier (6000) but is formed by twisting or otherwise commingling two of the same single-end yarns. Such a yarn can be identified as a 3000×2 yarn, which indicates that the yarn is a two-ply yarn, with each ply corresponding to a single-end yarn having a total denier of 3000. If the dpf of each of the single-end yarns is 15, then the number of filaments of each of the single-end yarns can be calculated by dividing the total denier (3000) by the dpf (15), producing a result of 200 filaments within each of the single-end yarns. Therefore, the total number of filaments within the two-ply yarn can be determined to be 600 (the sum of the number of filaments within the two single-end yarns that make up the two-ply yarn).

In yet another example, consider a yarn formed by twisting or otherwise commingling two different single-end yarns to form a yarn bundle. The yarn bundle can include a first single-end yarn that is a 3000 total denier, 15 dpf yarn and a second single-end yarn that is a 3000 total denier, 4 dpf yarn. This indicates that the first single-end yarn has a total denier of 3000, with each filament of the yarn having a denier (per filament) of 15. The second single-end yarn has a total denier of 3000, with each filament of the yarn having a denier (per filament) of 4. Thus, the first single-end yarn has 200 filaments (with each filament having a denier of 15 to provide a total denier of 3000), while the second single-end yarn has 750 filaments (with each filament having a denier of 4 to provide a total denier of 3000).

### Permeable Backing and Tufted Articles Having Permeable Backing

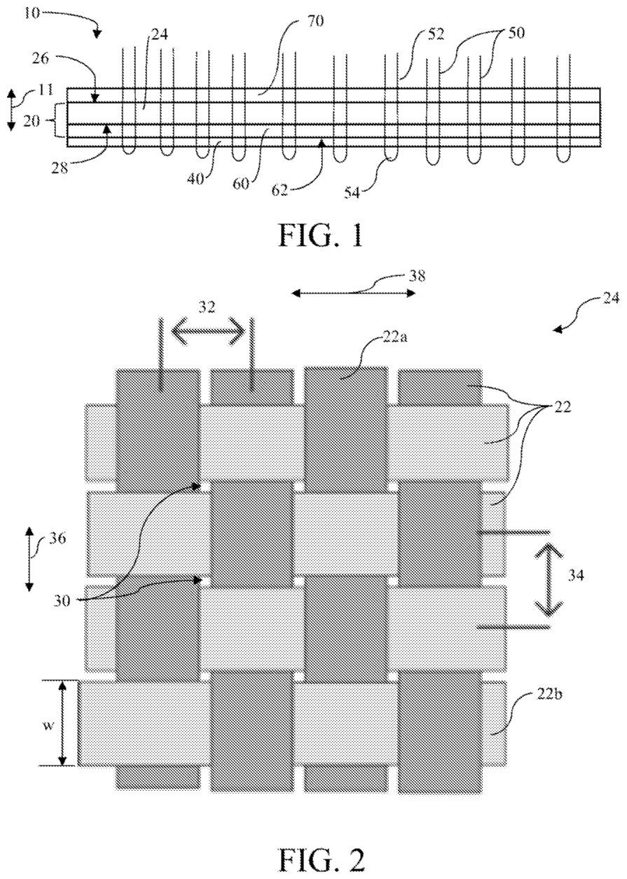

Referring to FIGS. 1-3, an exemplary tufted article 10 can have a backing 20. The backing 20 can comprise a plurality of woven fibers 22 that define a woven backing structure 24 having a first surface 26 and a second surface 28. The plurality of woven fibers 22 can comprise warp fibers 22a and weft fibers 22b. Optionally, the plurality of woven fibers 22 of the woven backing structure 24 can be arranged in a plain weave. In further aspects, the woven backing structure can have other arrangements. For example, the woven backing structure can be twill, plain, satin, sateen, basket, leno, tabby, combinations thereof, or the like. It is contemplated that the woven backing structure can be formed by a cam-driven loom, a Dobby loom, or a Jacquard loom as are known in the art.

Void spaces 30 can be defined between respective woven fibers of the plurality of woven fibers 22 of the woven backing structure 24. The void spaces 30 can be configured to permit passage of liquid or vapor from the first surface 26 to the second surface 28 of the woven backing structure 24.

In some aspects, the woven backing structure 24 can comprise tape yarns arranged in a flat weave construction. For example, in some aspects, both the warp fibers 22a and weft fibers 22b can be tape yarns.

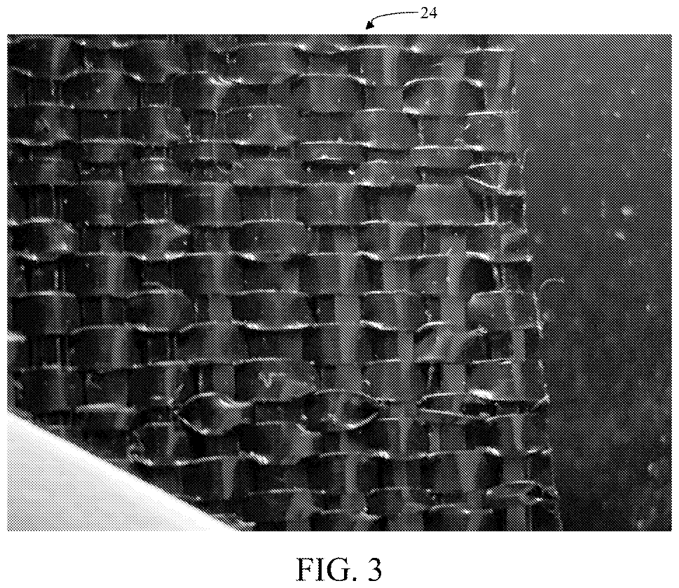

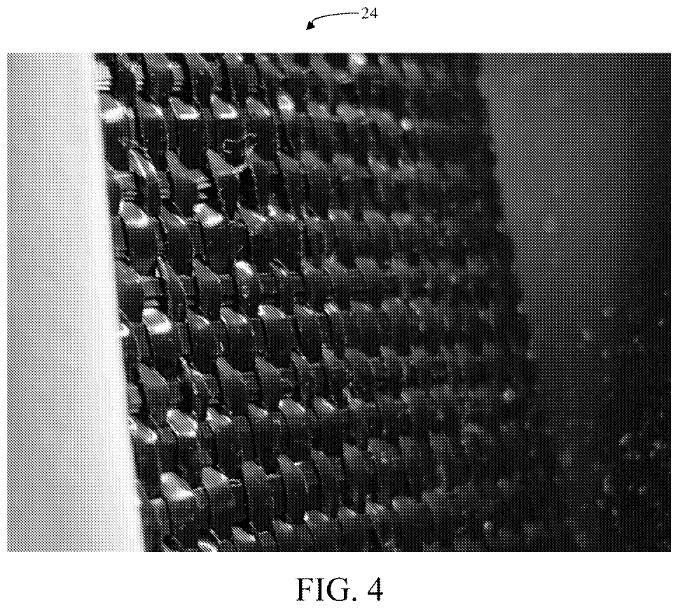

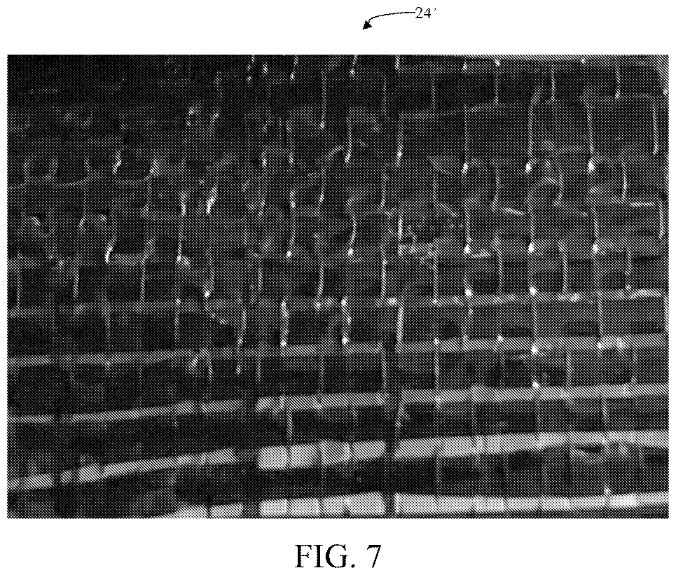

In exemplary aspects, the void spaces 30 can be provided by the weft fibers 22b having an undulating profile between the warp fibers 22a. More particularly, it was discovered that increasing the weight of the fibers (e.g., the thickness of the fibers) increases the amplitude of the undulation of the undulating structure, thereby forming large void spaces 30. For example, FIG. 7 shows a woven backing structure 24′ with thin fibers having a low amplitude of undulation, as compared to the fibers of FIGS. 3-6. The amplitude of undulation can be understood to be the distance along a vertical axis 11 that the fibers extend.

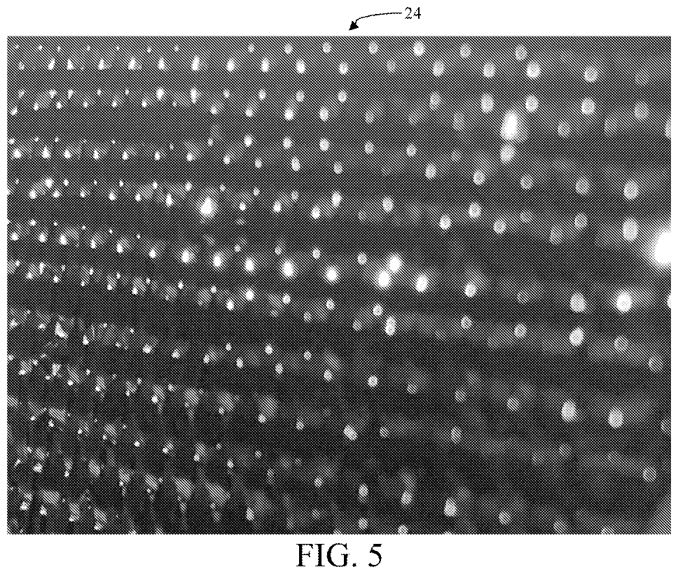

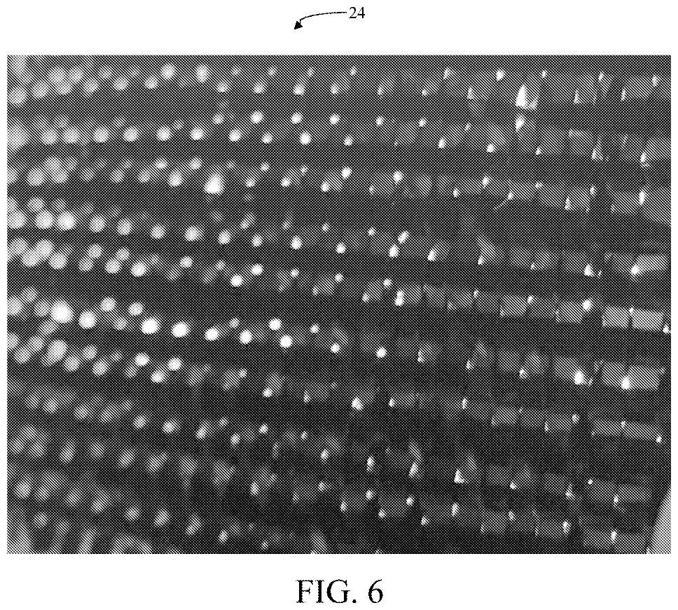

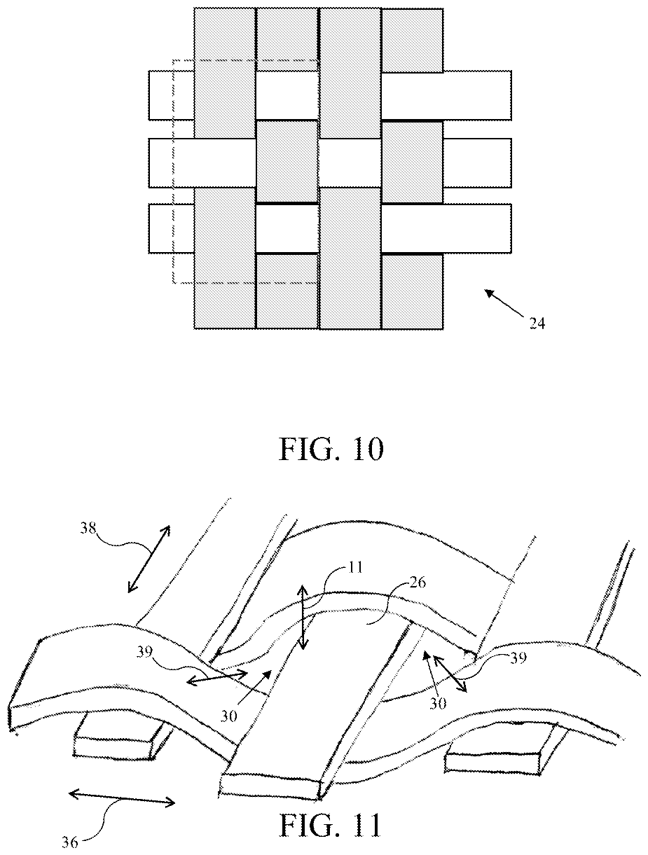

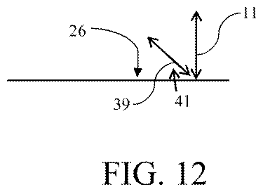

Accordingly, referring to FIGS. 3 and 10, in some aspects, a projection of the woven backing structure 24 into a plane that is parallel to the first surface along the vertical axis 11 does not have open areas, as illustrated by the absence of light that is visible through the woven backing structure. The woven backing structure 24 can, therefore, provide a continuous structure that is configured to fixedly hold face fibers, as further described herein. This can contrast to the woven backing structure as illustrated in FIG. 2 that shows a discontinuous structure, a projection of which into the plane does show open areas. Referring to FIGS. 11 and 12, in some aspects, the void spaces 30 can extend along axes 39 that form acute angles 41 relative to the first surface 26. That is, the void spaces 30 can be formed by variations in the vertical positions of adjacent fibers 22 of the woven backing structure 24 so that moisture can flow through the void spaces along the axes 39 that form the acute angles 41 relative to the first surface. Referring also to FIGS. 5-6, when viewing the woven backing structure 24 at an acute angle (e.g., 45 degrees) relative to the first surface 26, light can be seen therethrough, corresponding to the void spaces 30 that permit passage of liquid and vapor from the first surface 26 to the second surface 28. In some optional aspects, when viewing the woven backing structure 24 along the vertical axis 11, perpendicular to the first surface 26, the voids spaces 30 are not visible, as the continuous structure does not show the void spaces 30 along the vertical axis. In other aspects, the void spaces 30 are substantially not visible or are minimally visible when viewing the woven backing structure 24 along the vertical axis 11, but become fully viewable when viewed at an acute angle relative to the first surface 26.

In some aspects, the woven backing structure 24 can have from about 4 picks per inch to about 30 picks per inch (e.g., about 10 to about 28 picks per inch, or from about 5 picks per inch to about 20 picks per inch). For example, the woven backing structure 24 can have from 12 picks per inch to 18 picks per inch. Thus, in some exemplary aspects, it is contemplated that the woven backing structure 24 can have about 12 picks per inch, about 13 picks per inch, about 14 picks per inch, about 15 picks per inch, about 16 picks per inch, about 17 picks per inch, or about 18 picks per inch.

The plurality of woven fibers 22 of the woven backing structure 24 can have a weight from about 2.6 ounces per square yard to about 13 ounces per square yard, or from 1.5 ounces per yard to about 8 ounces per yard, or from about 4.5 ounces per square yard to about 8 ounces per square yard (e.g., optionally, from about 6 ounces per square yard to about 7 ounces per square yard). In further aspects, the plurality of woven fibers 22 can have a weight of about 8, about 9, about 10, about 11, about 12, or about 13 ounces per square yard.

It was discovered that the heavy denier (e.g. thicker ribbon) of the plurality of woven fibers 22 of the woven backing structure 24 provided a surprisingly high permeability. For example, a woven backing structure 24 having a weight of about 6 ounces per square yard was discovered to have three times the air permeability of a woven backing structure having the same picks per inch and a weight of about 3 ounces per square yard.

In some aspects, the warp fibers 22a can have center-to-center spacing 32 from 0.025 inches to 0.1 inches or from about 0.035 inches to about 0.075 inches. In some aspects, the weft fibers 22b can have center-to-center spacing 34 from 0.025 inches to 0.1 inches or from about 0.04 inches to about 0.09 inches.

In exemplary aspects, the warp fibers 22a can be from about 0.025 inches to 0.1 inches (e.g., about 0.05 inches) wide. In exemplary aspects, the warp fibers 22a can be from about 0.0025 inches to about 0.005 inches, or from about 0.003 inches to about 0.005 inches (e.g., about 0.035 inches) thick. In some aspects, the weft fibers 22b can be from 0.025 inches to 0.2 inches (e.g., about 0.01 inches) wide. In exemplary aspects, the warp fibers 22a can be from about 0.0025 inches to about 0.005 inches, or from about 0.003 inches to about 0.005 inches thick.

Still referring to FIGS. 1-2, the backing 20 can have a warp axis 36 and a weft axis 38. In some aspects, the woven fibers 22 can have a width w along the respective warp or weft axis 36, 38. It is contemplated that the center-to-center spacing 34 of the warp fibers 22b can be equal to, or substantially equal to, or less than, the width of the warp fibers along the weft axis 38. In this way, and with further reference to FIG. 10, the woven backing structure 24 can define the continuous structure that is configured to fixedly hold the face fibers (as opposed to the schematic drawing of FIG. 2 that shows spaces between the fibers and, thus, a discontinuous structure). For example, a projection of the continuous structure along the vertical axis 11 onto a plane perpendicular to the vertical axis can be continuous, having no openings within the projection. In still further aspects, the projection of the continuous structure along the vertical axis 11 onto the plane perpendicular to the vertical axis can have less than 5% open area, or less than 4% open area, or less than 3% open area, or less than 2% open area, or less than 1% open area, or substantially no open area. In these aspects, it is contemplated that the minimal amount of open area within the continuous structure does not have a meaningful effect on the ability of the continuous structure to fixedly hold the face fibers. In some optional aspects, the plurality of woven fibers 22 can have generally rectangular cross sections.

In some optional aspects, the backing 20 does not comprise formed perforations. That is, the only openings present within the backing are produced by the woven structure of the backing (and the resulting spaces between the woven fibers).

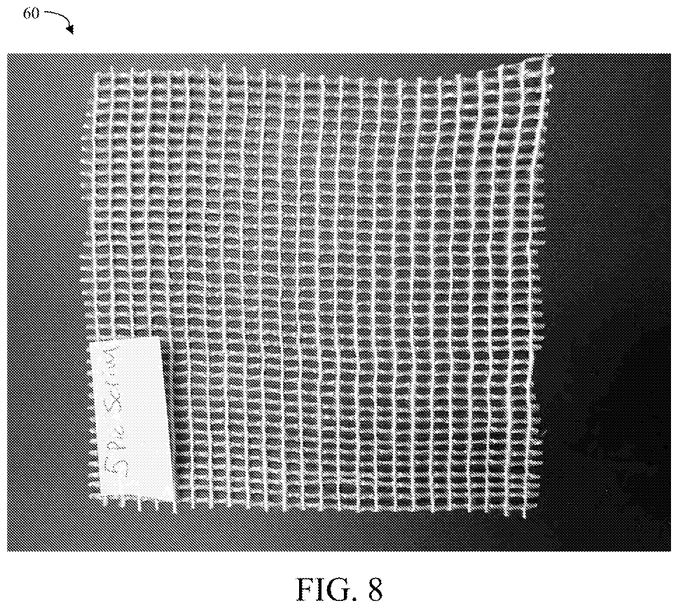

Referring to FIGS. 1 and 8, in some optional aspects, the backing 20 can further comprise a scrim layer 60 coupled to the second surface 28 of the woven backing structure 24. The scrim layer 60 can have an open mesh structure. Thus, a projection of the scrim layer into the plane that is parallel to the first surface of the woven backing structure 24 along the vertical axis can define open areas. For example, the scrim layer 60 can optionally have a leno or plain weave structure. Thus, the warp fibers of the weave structure can be spaced from each other and the weft fibers of the weave structure can be spaced from each other to provide openings through the scrim layer, as illustrated in FIG. 8. The leno weave structure can comprise either single or multiple yarns extending in the warp and weft directions. In further aspects, the scrim layer 60 can be knitted. In yet other aspects, the scrim layer 60 can comprise a nonwoven material (e.g., open meltblown material, needlepunched material, spunbond material, water jet-formed material, or air-layed material). Optionally, the scrim can have about 5 picks per inch. The woven backing structure 24 and the scrim layer 60 can cooperate to define a lower surface 62 of the backing 20. In exemplary aspects, the scrim layer can have a weight ranging from about 1 to about 3 ounces per square yard. In some optional aspects, the scrim layer can have from 4 to 30 warp ends per inch and from 2 to 18 picks per inch. Optionally, the scrim layer can comprise warp yarn comprising flat tape with a denier from 100 to 500. Optionally, the scrim layer can comprise fill yarn that is from about 400 denier to about 2400 denier. In exemplary aspects, it is contemplated that the weft yarn can comprise air-textured filament, spun, bulk continuous filament, continuous filament, flat tape, or fibrillated yarns.

The tufted article 10 can further comprise a second plurality of fibers 50 tufted through the backing and extending upwardly from the first surface 26 of the woven backing structure 24. The tufted fibers can optionally be looped or cut. The second plurality of fibers 50 can be face fibers of the tufted article that have backstitches 54 that loop behind both the scrim layer 60 and the backing 20.

Optionally, a polymer coating 40 can be applied to the lower surface 62 of the backing 20 and the scrim layer 60. That is, the polymer coating 40 can be applied to the second surface 28 of the woven backing structure 24 and across the scrim layer 60. The polymer coating 40 can couple the second plurality of fibers 50 to the backing to inhibit movement of the second plurality of fibers relative to the backing (e.g., to prevent the second plurality of fibers from falling out of the backing). In some aspects, the polymer coating 40 can comprise polyurethane.

At least a portion of the scrim 60 can prevent the polymer coating 40 from entering (e.g., blocking) at least one void space of the void spaces defined between respective woven fibers of the plurality of woven fibers of the woven backing structure. That is, the scrim layer 60 can inhibit the polymer coating 40 from filling some or all of the void spaces 30 through the woven backing structure 20. The scrim layer 60 can further provide dimensional stability to the tufted article.

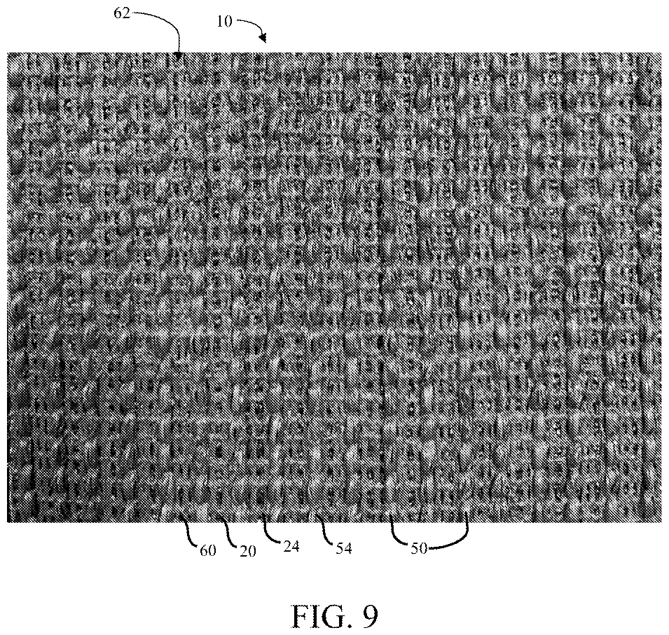

FIG. 9 illustrates a lower side of the tufted article 10, showing the backstitches 54 of the second plurality of fibers 50, the backing 20, and the scrim layer 60. As illustrated, the polymer coating 40 can be applied to the backstitches 54 of the second plurality of fibers 50, the backing 20, and the scrim layer 60. In exemplary aspects, following tufting of the second plurality of fibers 50 as disclosed herein, a coating machine as is known in the art can be used to apply the polymer coating 40.

In some aspects, the tufted article 10 can comprise only a single layer of the woven backing structure 24 (in addition to the scrim layer 60). That is, the tufted article 10 can comprise the a single woven backing structure 24 and a scrim layer 60 and no additional woven layers. It is contemplated that having only a single backing layer can provide advantageous permeability. This can contrast with articles having multiple lower-weight woven backing structure layers that are applied together.

Optionally, the tufted article 10 can comprise infill 70 (e.g., sand). The infill can optionally be provided at a weight ranging from about 1 lb/sq. yard to about 9 lb/sq. yard. In these aspects, it is contemplated that the infill can comprise a single component or any combination of a plurality of components. When the infill comprises a plurality of components, it is contemplated that the infill material can optionally comprise a plurality of layers, with each layer corresponding to a different infill component or combination of components. Alternatively, it is contemplated that the plurality of components can be provided as a mixture, which can be either homogenous or non-homogenous. In exemplary aspects, it is contemplated that the infill can comprise clay, TPE, EPDM, coconut husks, walnut shells, crushed brick, sand, or combinations thereof. More generally, it is contemplated that the infill can comprise any material that is capable of imparting desired characteristics to a surface covering (e.g., a floor or ground covering) as disclosed herein. In further aspects, the tufted article 10 does not comprise infill (and is not filled during use).

Optionally, the second plurality of fibers 50 can comprise yarn.

The tufted article 10 can optionally be an artificial turf. In these aspects, the artificial turf can permit high flow water drainage therethrough. In exemplary aspects, a plurality of tufted articles 10 can form at least a portion of a playing surface, such as for example and without limitation, a sports field, a golf course, or a park. In further exemplary aspects, it is contemplated that one or more tufted articles 10 can form at least a portion of an airport runway, a landfill cover, or the like.

In further aspects, the tufted article 10 can be carpet (e.g., commercial or residential carpet). The breathability of the disclosed backing 20 can advantageously allow moisture to escape from a subfloor beneath the tufted article. In exemplary aspects, it is contemplated that a plurality of tufted articles 10 can form at least a portion of a surface (e.g., floor) covering.

In some aspects, a method can comprise coupling a tufted article 10 as disclosed herein to a substructure and receiving liquid (e.g., water) or water vapor through the void spaces defined between respective woven fibers of the plurality of woven fibers of the woven backing structure. In exemplary aspects, the substructure can be a subfloor. In various other aspects, the tufted article 10 can be installed on other substructures, such as, for example and without limitation, a sub-base (e.g., gravel) or a pad platform (e.g., an underlay). In further aspects, the tufted article 10 can receive and permit passage of particles through the void spaces.

The tufted article 10 can be formed in accordance with methods disclosed herein. The second plurality of fibers 50 can be tufted through the backing 20 so that the plurality of fibers extend upwardly from the first surface of the woven backing structure. In some aspects, the method does not include forming openings through the backing. In some aspects, the plurality of fibers 22 can be woven together to form the woven backing structure 24 having the first surface 26 and the opposed second surface 28, with the woven backing structure defining void spaces 30 between respective woven fibers of the plurality of woven fibers of the woven backing structure. The void spaces 30 can be configured to permit passage of liquid from the first surface 26 to the second surface 28 of the woven backing structure 24.

Prior to tufting the second plurality of fibers through the woven backing structure 24, the scrim layer 60 can be positioned against the second surface of the woven backing structure to provide the backing 20, the scrim layer having an open mesh structure. The polymer coating 40 can be applied to the lower surface 62 of the backing 20. For example, in some aspects, the polymer coating can be rolled against the lower surface 62 of the backing 20. In alternative aspects, the polymer coating can be poured as a fluid onto the lower surface 62 of the backing 20, and the fluid can be scraped across the lower surface of the backing 20 to distribute the fluid across the lower surface. This can be referred to as puddle underknife or scrape bar application.

In exemplary aspects, the plurality of woven fibers 22 and/or the second plurality of fibers 50 can comprise polymer (e.g., nylon, polypropylene (PP), polyethylene (PE), or polyethylene terephthalate (PET)). In some aspects, the woven backing structure 24 can comprise PP. In various aspects, the plurality of woven fibers 22 and/or the second plurality of fibers 50 can comprise virgin and/or recycled materials. In further aspects, the plurality of woven fibers 22 and/or the second plurality of fibers 50 can comprise natural materials, such as, for example, soy, sugar cane, jute, hemp, etc.

Although various exemplary yarn deniers are described herein, it is contemplated that exemplary yarns of the tufted article 10 can optionally have a total denier anywhere within a range from 500 to 23,000. In further aspects, it is contemplated that the yarns can optionally have a denier per filament within a range from 4 to 2700 dpf.

### Additional Exemplary Embodiments

Although embodiments disclosed herein describe use of a woven backing structure for holding the face fibers while permitting water permeation therethrough, it is contemplated that other open structure materials having openings for water, vapor, and/or particle permeability can be used. Optimally, it is contemplated that such open structure materials can derive their permeability in part from the texture of the material (e.g., variability of the fibers along a vertical axis 11) rather than solely from the spacing between fibers in horizontal axes (e.g., warp and weft axes 36, 38). Thus, in further embodiments, a knitted structure or a nonwoven material can be used in place of the woven backing structure 24.

In some optional aspects, the polymer coating 40 can be omitted from the tufted article 10. In other aspects, the polymer coating 40 can be disposed on the opposite side of the open structure material (e.g., on the first surface 26 the woven backing structure 24).

In some optional aspects, the positions of the open structure material (e.g., the woven backing structure 24) and the scrim layer 60 can be reversed from what is shown in FIG. 1. That is, for example, the scrim layer 60 can be positioned on the first surface 26 of the woven backing structure 24 (or other open structure material).

In still further aspects, the backing 20 can comprise a woven backing structure 24 (or other open structure material), a woven material, and a nonwoven material. For example, the backing 20 can comprise a woven backing structure 24, a nonwoven material disposed on the first surface 26 of the woven backing structure, and a woven material disposed on the second surface 28 of the woven backing structure.

### Exemplary Aspects of the Second Plurality of Fibers

In some exemplary aspects, the second plurality of fibers 50 can be formed into a plurality of yarn tufts 52 that extend through the backing 20. In these aspects, it is contemplated that the plurality of yarn tufts can be formed using conventional methods. For example, in these aspects, it is contemplated that one or more tufting machines can have a plurality of needles (optionally, on a needle bar) that deliver yarn into the backing 20 to form the plurality of yarn tufts 52. Optionally, it is contemplated that the backing 20 can be provided on a feed roll that feeds the backing through the tufting machine(s).

Although depicted in the drawings as comprising cut tufts, it is contemplated that the tufts of the tufted article 10 can comprise cut tufts, loop tufts, or combinations thereof. Each tuft 40 of the plurality of tufts can comprise at least one outwardly extending tuft portion (positioned above the backing) and a backstitch connected to the at least one outwardly extending tuft portion. In exemplary aspects, when the plurality of tufts comprise cut tufts, each yarn tuft of the plurality of yarn tufts can have at least one pair of outwardly extending tuft portions (positioned above the backing and formed by a respective cut) that are joined by a backstitch (positioned beneath or within the backing). When a tuft comprises a single yarn, it is contemplated that the tuft can comprise a single pair of tuft portions, which are joined by a single backstitch. However, when a tuft comprises a plurality of yarns (for example, two or three yarn ends that are delivered concurrently through a backing by a single needle through which each of the two or three yarn ends is threaded), then the tuft can comprise a plurality of pairs of tuft portions (one pair for each yarn), with each pair of tuft portions being joined by a respective backstitch portion.

Although exemplary structures for associating the second plurality of fibers 50 with the backing are disclosed herein (e.g., tufting), it is contemplated that any conventional mechanical or structural association between the second plurality of fibers 50 and the backing can be employed.

In exemplary aspects, the second plurality of fibers 50 can comprise a plurality of yarn filaments. In some optional aspects, each yarn filament of the plurality of yarn filaments can have a denier ranging from 61 to 3600 denier per filament (dpf), such as is typically found in an artificial turf yarn. Optionally, in these aspects, it is contemplated that each yarn filament can have a denier ranging from 61 to 1000 dpf or from 61 to 750 dpf or from 400 to 600 dpf. However, it is contemplated that other dpf values can be used depending on the particular application and desired performance properties.

In further aspects, it is contemplated that the second plurality of fibers 50 can comprise a plurality of yarn filaments. In these aspects, each yarn filament of the plurality of yarn filaments of the second plurality of fibers 50 can optionally have a denier per filament (dpf) ranging from 2 to 60 dpf, such as is typically found in a carpet yarn. Optionally, in these aspects, each yarn filament of the plurality of yarn filaments can have a denier per filament (dpf) ranging from 6 to 60 dpf or from 10 to 40 dpf. Thus, in some aspects, it is contemplated that at least one yarn of the tufted article 10 can comprise a turf yarn, while at least one other yarn of the tufted article can comprise a carpet yarn. Accordingly, in these aspects, the tufted article 10 can function as a hybrid turf-carpet article, providing a combination of the properties offered (separately) by turf and carpet products. For example, it is contemplated that turf yarns can impart desired performance/durability properties, while carpet yarns can impart desired softness and texture properties. As further disclosed herein, it is further contemplated that turf or carpet properties can be selectively emphasized or deemphasized by controlling various properties of the yarns. It is contemplated that the second plurality of fibers 50 can comprise any desired number of filaments, such as, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 36, 48, 96, or up to 4000 individual filaments per yarn.

Optionally, in some exemplary aspects, it is contemplated that the yarn filaments of the second plurality of fibers 50 can have a dpf ranging from 2 to 32. In these aspects, it is contemplated that the second plurality of fibers 50 can be a conventional residential carpet yarn as is known in the art.

Optionally, in some exemplary aspects, it is contemplated that the yarn filaments of the second plurality of fibers 50 can have a dpf ranging from 22 to 60. In these aspects, it is contemplated that the second plurality of fibers 50 can be a conventional commercial carpet yarn as is known in the art.

As described above, in some exemplary aspects, the second plurality of fibers 50 can be provided within each respective tuft or pile extending through the backing. In one exemplary process, fiber is hung on a creel and then the fiber ends are fed through respective tubes until reaching a guide structure immediately before the needle bar of the tufting machine. At the guide structure, the fibers are fed together through one guide hole, and both fibers can be delivered at the same rate to each needle of a tufting machine. One or more ends per needle can be tufted with adjustments made for tension so that the fibers pick up on the hooks for cutting. Optionally, one of the fibers can be straight-set, and one of the fibers can be texturized, so adjustments for tension can be necessary to ensure successful tufting. Alternatively, in other exemplary processes, the fibers can pass through the same tubes all the way to the needles for tufting. It is contemplated that the needle size and the hole or eye of the needle can be selected based on the gauge and the density that is desired for the final article.

It is contemplated that any desired number of different fibers (e.g., yarns) can be provided within a tufted article as disclosed herein. For example, it is contemplated that a second yarn and a third yarn can be provided along with a first yarn within each tuft of the plurality of tufts. In still further aspects, four, five, or more yarns can be provided in each tuft of the plurality of tufts.

### Exemplary Material Properties

In exemplary aspects, it is contemplated that each yarn filament of the second plurality of fibers 50 can be a monofilament. Optionally, in these aspects, each yarn filament of the second plurality of fibers 50 can be a 100% nylon monofilament. In these aspects, it is contemplated that the nylon of the second plurality of fibers can be nylon-6, nylon-6,6, or other conventional forms of nylon. In some optional aspects, it is contemplated that the second plurality of fibers 50 of the tufted article 10 can consist of a single yarn, wherein each filament of the yarn is a monofilament.

In other exemplary aspects, the second plurality of fibers 50 can consist of nylon. In further exemplary aspects, it is contemplated that each filament of the second plurality of fibers 50 can comprise a continuous filament.

As described above, in exemplary aspects, the yarn filaments of the second plurality of fibers 50 can optionally be unpigmented natural filaments. In these aspects, it is contemplated that the second plurality of fibers 50 can be solution-dyed on a “natural” setting without color pigment added during extrusion.

In further aspects, it is contemplated that the second plurality of fibers 50 can comprise a 4400/8 monofilament yarn, having a total denier of 4400 and a dpf of 550 (with a total of 8 monofilaments provided within the yarn). In another example, the second plurality of fibers 50 can comprise a 4400/16 monofilament yarn, having a total denier of 4400 and a dpf of 275 (with a total of 16 monofilaments provided within the yarn). In yet another example, the second plurality of fibers 50 can comprise a 4400/32 yarn, with a total denier of 4400 and a dpf of 137.5 (with a total of 32 monofilaments provided within the yarn). In yet another example, the second plurality of fibers 50 can comprise a 6600/8 monofilament yarn, with a total denier of 6600 and a dpf of 825 (with a total of 8 monofilaments provided within the yarn). In yet another example, the second plurality of fibers 50 can comprise a 6600/12 monofilament yarn, with a total denier of 6600 and a dpf of 550 (with a total of 12 monofilaments provided within the yarn). In still another example, the second plurality of fibers 50 can comprise a 6600/24 monofilament yarn, with a total denier of 6600 and a dpf of 275 (with a total of 24 monofilaments provided within the yarn). In further exemplary, optional aspects, the second plurality of fibers 50 can comprise 800/2 (total denier 1600), 800/3 (total denier 2400), 1000/2 (2000 denier), 1000/3 (3000 total denier), or 1000/4 (4000 total denier) fibers. In further exemplary, optional aspects, the second plurality of fibers 50 can comprise 2600×3 ply (7800 total denier), 2600×2 ply (5200 total denier), 1400 denier×2 ply, or 1800 denier×2 ply fibers. In exemplary aspects, the second plurality of fibers 50 can have a denier per filament from about 4 to about 30. More generally, it is contemplated that any desired total denier can be used for the second plurality of fibers 50, provided the individual monofilaments of the second plurality of fibers 50 have a dpf that is consistent with the desired performance properties of the article. Optionally, in exemplary aspects, each fiber of the second plurality of fibers 50 can have a total denier ranging from about 500 to about 25,000 or from about 3,000 to about 8,000 or from about 4,000 to about 7,000. In exemplary aspects, it is contemplated that at least one fiber of the second plurality of fibers can comprise a multi-ply yarn.

It is contemplated that the cross sectional profile of each filament of the second plurality of fibers 50 can be any shape that is conventionally used for turf yarns. For example, in some exemplary aspects, each filament of the second plurality of fibers 50 can have a cross-sectional profile comprising a diamond shape, a serrated diamond shape, a half-moon shape, or an oval or round shape. However, it is contemplated that any desired cross-sectional profile can be used. It is further contemplated that the second plurality of fibers 50 can have desirable durability and colorfastness properties.

As explained above, in exemplary aspects, the second plurality of fibers 50 of the tufted article can comprise a conventional turf yarn and/or a conventional carpet yarn. In exemplary tufted articles, the second plurality of fibers 50 can comprise nylon (e.g., nylon-6 or nylon-6,6), polyester, or polypropylene. In one example, the second plurality of fibers 50 can comprise a 1362/2 ply (1362×2) continuous filament nylon yarn, with a total denier of 2724. As another example, the second plurality of fibers 50 can comprise solution dyed nylon 1350/5 ply (1350×5) yarn, with a total denier of 6,750. In these examples, it is contemplated that each ply of the yarns can comprise any desired number of filaments, with the dpf remaining below 60. In various aspects, it is contemplated that each filament of the second plurality of fibers 50 can be either a continuous filament or a non-continuous filament.

In some exemplary aspects, it is contemplated that second plurality of fibers 50 can be a multiple end yarn formed from at least two distinct single end yarns (at least two ply). In these aspects, it is contemplated that at least two distinct single end yarns that form the multiple end yarn can have different dpf values that allow for creating distinct visual effects. For example, it is contemplated that the second plurality of fibers 50 can comprise a first yarn end having a 65 dpf value and a second yarn end having a 65 dpf value, wherein both the first and second yarn ends consist of monofilaments. It is further contemplated that the second yarn can comprise a first yarn end having a 2 dpf value and a second yarn end having a 30 dpf value.

In exemplary aspects, it is contemplated that the materials of the second plurality of fibers 50 of the tufted article 10 can be selected based upon the intended use of the tufted article. For example, nylon, PP, PE and PET are all suitable for indoor use, but nylon and PET will not hold up as well as PP or PE during outdoor use. However, for printing or dyeing yarns as disclosed herein, it is contemplated that special dyes or paints can be needed to impart color to PP and PE yarns. In some aspects, it is contemplated that one of the yarns can comprise PP and/or PE yarns while another of the yarns can comprise nylon. In these aspects, it is contemplated that during a printing or dyeing process, color can be imparted to the nylon yarn while color is not imparted to the PP and/or PE yarns (due to the absence of the special dyes or paints needed to impart color to PP and/or PE yarns), thereby producing unique face appearances. Thus, in some aspects, the color patterns disclosed herein do not impart color to some of the face yarns, even if paint or dye is applied to those face yarns. In various further aspects, the plurality of fibers 50 of the tufted article 10 can comprise polylactic acid (PLA), polyurethane (PU), natural fibers (e.g., optionally, soy, sugar cane, etc.), or other fibers that are biodegradable or at least semi-biodegradable.

It is contemplated that the cross sectional profile of each filament of the second plurality of fibers 50 can be any shape that is conventionally used for carpet yarns. For example, in some exemplary aspects, the filaments of the second plurality of fibers 50 can each have a cross-sectional profile having a tri-lobal shape as is known in the art. It is contemplated that the cross-sectional profile of the filaments of the second plurality of fibers 50 can be selected to impart desired luster, firmness/softness, resiliency, and other properties. It is contemplated that the yarn density of the tufted articles can determine the final surface interactions between the yarns and a ball or a human when the tufted article is used in a flooring/playing surface installation. For example, the yarn density can be modified to provide a desired amount of friction when the yarn interacts with shoes. In further aspects, it is contemplated that yarn densities can be varied along the surface of the tufted article. For example, in these aspects, it is contemplated that the yarn density can change at locations where the face structure of the tufted article changes (e.g., a change in color, yarn type, bulkiness, pile heights, and the like). In exemplary aspects, as further disclosed herein, it is contemplated that a pad (e.g., a polyurethane pad) can be added to the tufted article at locations where carpet surface properties change, thereby increasing human safety. In further optional aspects, a system can comprise a tufted article herein and an underlay (e.g., a pad). In various optional aspects, the tufted article can be attached to or unattached to the underlay.

It is contemplated that the second plurality of fibers 50 of the tufted article 10 can be colored in any desired manner prior to the application of a color pattern as further disclosed herein. For example, as further explained herein, the second plurality of fibers 50 can be an unpigmented natural yarn that is not pre-dyed, or second plurality of fibers can be pre-dyed. In another example, both the second plurality of fibers 50 can be pre-dyed or solution-dyed.

It is further contemplated that the cross-sectional shapes and/or sizes of the fibers/yarns can be selectively varied to modify color and texture as further disclosed herein.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A tufted article comprising:
a backing comprising:
   a plurality of woven fibers defining a woven backing structure having a first surface and an opposed second surface, wherein void spaces are defined between respective woven fibers of the plurality of woven fibers of the woven backing structure, and wherein the void spaces are configured to permit passage of liquid or vapor from the first surface to the second surface of the woven backing structure; and
   a scrim layer coupled to the opposed second surface of the woven backing structure, wherein the scrim layer has an open mesh structure,
   wherein the second surface of the woven backing structure and the scrim layer cooperate to define a lower surface of the backing.

Aspect 2: The tufted article of aspect 1, further comprising a polymer coating applied to the lower surface of the backing, wherein at least a portion of the scrim prevents the polymer coating from entering at least one void space of the void spaces defined between respective woven fibers of the plurality of woven fibers of the woven backing structure.

Aspect 3: The tufted article of aspect 1 or aspect 2, wherein the scrim layer comprises a leno weave.

Aspect 4: The tufted article of any one of the preceding aspects, wherein a projection of the backing along a vertical axis and into a plane that is parallel to the first surface does not have open areas.

Aspect 5: The tufted article of aspect 4, wherein a projection of the scrim layer along the vertical axis and into said plane defines open areas.

Aspect 6: The tufted article of any one of the preceding aspects, wherein the plurality of woven fibers of the woven backing structure of the backing comprise from 5 to 20 picks per inch, and wherein the woven backing structure has a weight from about 1.5 ounces per square yard to about 8 ounces per square yard.

Aspect 7: The tufted article of any one of the preceding aspects, wherein the plurality of woven fibers of the woven backing structure of the backing comprise from 12 to 18 picks per inch.

Aspect 8: The tufted article of any one of the preceding aspects, wherein the woven backing structure has a weight from about 6 ounces per square yard to about 7 ounces per square yard.

Aspect 9: The tufted article of any one of the preceding aspects, wherein the plurality of woven fibers of the woven backing structure are arranged in a plain weave.

Aspect 10: The tufted article of any one of the preceding aspects, wherein the backing does not comprise formed perforations.

Aspect 11: The tufted article of any one of the preceding aspects, wherein each fiber of the plurality of woven fibers of the woven backing structure has a generally rectangular cross section.

Aspect 12: The tufted article of any one of aspects 2-11, wherein the polymer coating comprises polyurethane.

Aspect 13: The tufted article of any one of the preceding aspects, further comprising a second plurality of fibers tufted through the backing and extending upwardly from the first surface of the woven backing structure.

Aspect 14: The tufted article of any one of the preceding aspects, further comprising infill.

Aspect 15: The tufted article of aspect 14, wherein the infill comprises sand.

Aspect 16: The tufted article of aspect 14 or aspect 15, wherein the infill is provided at a weight ranging from about 1 lb/sq yd to about 3 lb/sq yd.

Aspect 17: The tufted article of any one of aspects 13-16, wherein the second plurality of fibers comprise yarn.

Aspect 18: The tufted article of any one of aspects 13-16, wherein the tufted article is an artificial turf.

Aspect 19: The tufted article of any one of aspects 13-16, wherein the tufted article is carpet.

Aspect 20: A method of forming a tufted article, the method comprising:
weaving a plurality of fibers together to form a woven backing structure having a first surface and an opposed second surface, the woven backing structure defining void spaces between respective woven fibers of the plurality of woven fibers of the woven backing structure, and wherein the void spaces are configured to permit passage of liquid or vapor from the first surface to the second surface of the woven backing structure; and
tufting a second plurality of fibers through the woven backing structure so that the plurality of fibers extend upwardly from the first surface of the woven backing structure,
wherein following weaving of the plurality of fibers together, the method does not include forming openings through the woven backing structure.

Aspect 21: The method of aspect 20, further comprising:
positioning, prior to tufting the second plurality of fibers through the woven backing structure, a scrim layer against the second surface of the woven backing structure to provide a backing, wherein the scrim layer has an open mesh structure, wherein the second surface of the woven backing structure and the scrim layer cooperate to define a lower surface of the backing.

Aspect 22: The method of aspect 21, further comprising applying a polymer coating to the lower surface of the backing.

Aspect 23: The method of aspect 22, wherein applying the polymer coating to the lower surface of the backing comprises rolling the polymer coating against the lower surface of the backing.

Aspect 24: The method of aspect 22, wherein applying the polymer coating to the lower surface of the backing comprises:
pouring the polymer coating as a fluid onto the lower surface of the backing; and
scraping the fluid to distribute the fluid across the lower surface of the backing.

Aspect 25: A method comprising:
installing a tufted article as in any one of aspects 1-19 on a substructure; and
receiving liquid or water vapor through the void spaces defined between respective woven fibers of the plurality of woven fibers of the woven backing structure.

Aspect 26: A tufted article comprising:
a backing having a vertical axis, the backing comprising:
   an open structure material having a first surface and an opposed second surface, wherein the open structure material comprises a plurality of fibers, wherein the plurality of fibers define void spaces through the open structure material from the first surface to the second surface in part based on variability of fibers along the vertical axis, wherein the void spaces are configured to permit passage of liquid or vapor from the first surface to the second surface of the open structure material;
   a scrim layer coupled to the opposed second surface of the open structure material, wherein the scrim layer has an open mesh structure; and
a second plurality of fibers tufted through the backing and extending upwardly from the first surface of the open structure material.

Aspect 27: The tufted article of aspect 26, wherein the open structure material comprises a plurality of woven fibers defining a woven backing structure, wherein the void spaces are defined between respective woven fibers of the plurality of woven fibers of the woven backing structure, and wherein the void spaces are configured to permit passage of liquid or vapor from the first surface to the second surface of the woven backing structure.

Aspect 28: The tufted article of aspect 26, wherein the plurality of fibers of the open structure material comprises knitted fibers.

Aspect 29: The tufted article of aspect 26, wherein the plurality of fibers of the open structure material comprises nonwoven material.

Aspect 30: The tufted article of any one of aspects 26-29, wherein the second surface of the open structure material and the scrim layer cooperate to define a lower surface of the backing, wherein the tufted article further comprises a polymer coating applied to the lower surface of the backing, wherein at least a portion of the scrim prevents the polymer coating from entering at least one void space of the void spaces defined between respective woven fibers of the plurality of woven fibers of the open structure material

Aspect 31: The tufted article of any one of aspects 26-29, wherein the tufted article does not comprise a polymer coating.

Although the foregoing invention has been described in some detail by way of illustration and example for purposes of clarity of understanding, certain changes and modifications may be practiced within the scope of the appended claims.

What is claimed is:

1. A tufted article comprising:
a backing comprising:
a plurality of woven fibers defining a woven backing structure having a first surface and an opposed second surface, wherein void spaces are defined between respective woven fibers of the plurality of woven fibers of the woven backing structure, and wherein the void spaces are configured to permit passage of liquid or vapor from the first surface to the second surface of the woven backing structure; and
a scrim layer coupled to the opposed second surface of the woven backing structure, wherein the scrim layer has an open mesh structure,
wherein the second surface of the woven backing structure and the scrim layer cooperate to define a lower surface of the backing.

2. The tufted article of claim 1, further comprising a polymer coating applied to the lower surface of the backing, wherein at least a portion of the scrim prevents the polymer coating from entering at least one void space of the void spaces defined between respective woven fibers of the plurality of woven fibers of the woven backing structure.

3. The tufted article of claim 1, wherein the scrim layer comprises a leno weave.

4. The tufted article of claim 1, wherein a projection of the backing along a vertical axis and into a plane that is parallel to the first surface does not have open areas.

5. The tufted article of claim 4, wherein a projection of the scrim layer along the vertical axis and into said plane defines open areas.

6. The tufted article of claim 1, wherein the plurality of woven fibers of the woven backing structure of the backing comprise from 5 to 20 picks per inch, and wherein the woven backing structure has a weight from about 1.5 ounces per square yard to about 8 ounces per square yard.

7. The tufted article of claim 1, wherein the plurality of woven fibers of the woven backing structure of the backing comprise from 12 to 18 picks per inch.

8. The tufted article of claim 1, wherein the woven backing structure has a weight from about 6 ounces per square yard to about 7 ounces per square yard.

9. The tufted article of claim 1, wherein the plurality of woven fibers of the woven backing structure are arranged in a plain weave.

10. The tufted article of claim 1, wherein the backing does not comprise formed perforations.

11. The tufted article of claim 1, wherein each fiber of the plurality of woven fibers of the woven backing structure has a generally rectangular cross section.

12. The tufted article of claim 2, wherein the polymer coating comprises polyurethane.

13. The tufted article of claim 1, further comprising a second plurality of fibers tufted through the backing and extending upwardly from the first surface of the woven backing structure.

14. The tufted article of claim 1, further comprising infill.

15. The tufted article of claim 14, wherein the infill comprises sand.

16. The tufted article of claim 14, wherein the infill is provided at a weight ranging from about 1 lb/sq yd to about 3 lb/sq yd.

17. The tufted article of claim 13, wherein the second plurality of fibers comprise yarn.

18. The tufted article of claim 13, wherein the tufted article is an artificial turf.

19. The tufted article of claim 13, wherein the tufted article is carpet.

20. A method of forming a tufted article, the method comprising:
weaving a plurality of fibers together to form a woven backing structure having a first surface and an opposed second surface, the woven backing structure defining void spaces between respective woven fibers of the plurality of woven fibers of the woven backing structure, and wherein the void spaces are configured to permit passage of liquid or vapor from the first surface to the second surface of the woven backing structure; and
tufting a second plurality of fibers through the woven backing structure so that the plurality of fibers extend upwardly from the first surface of the woven backing structure,
wherein following weaving of the plurality of fibers together, the method does not include forming openings through the woven backing structure.

21. The method of claim 20, further comprising:
positioning, prior to tufting the second plurality of fibers through the woven backing structure, a scrim layer against the second surface of the woven backing structure to provide a backing, wherein the scrim layer has an open mesh structure, wherein the second surface of the woven backing structure and the scrim layer cooperate to define a lower surface of the backing.

22. (canceled)

23. (canceled)

24. (canceled)

25. A method comprising:
installing a tufted article as in claim 1 on a substructure; and
receiving liquid or water vapor through the void spaces defined between respective woven fibers of the plurality of woven fibers of the woven backing structure.

26. A tufted article comprising:
a backing having a vertical axis, the backing comprising:
an open structure material having a first surface and an opposed second surface, wherein the open structure material comprises a plurality of fibers, wherein the plurality of fibers define void spaces through the open structure material from the first surface to the second surface in part based on variability of fibers along the vertical axis, wherein the void spaces are configured to permit passage of liquid or vapor from the first surface to the second surface of the open structure material;
a scrim layer coupled to the opposed second surface of the open structure material, wherein the scrim layer has an open mesh structure; and
a second plurality of fibers tufted through the backing and extending upwardly from the first surface of the open structure material.

27. The tufted article of claim 26, wherein the open structure material comprises a plurality of woven fibers defining a woven backing structure, wherein the void spaces are defined between respective woven fibers of the plurality of woven fibers of the woven backing structure, and wherein the void spaces are configured to permit passage of liquid or vapor from the first surface to the second surface of the woven backing structure.

28. The tufted article of claim 26, wherein the plurality of fibers of the open structure material comprises knitted fibers.

29. The tufted article of claim 26, wherein the plurality of fibers of the open structure material comprises nonwoven material.

30. The tufted article of claim 26, wherein the second surface of the open structure material and the scrim layer cooperate to define a lower surface of the backing, wherein the tufted article further comprises a polymer coating applied to the lower surface of the backing, wherein at least a portion of the scrim prevents the polymer coating from entering at least one void space of the void spaces defined between respective woven fibers of the plurality of woven fibers of the open structure material.

31. The tufted article of claim 26, wherein the tufted article does not comprise a polymer coating.
